(19) United States
(12) Patent Application Publication
(10) Pub. No.: US 2020/0084387 A1
(43) Pub. Date: Mar. 12, 2020

(54) LOW POWER MODE FOR ONE OR MORE CAMERAS OF A MULTIPLE CAMERA SYSTEM

(71) Applicant: QUALCOMM Incorporated, San Diego, CA (US)

(72) Inventors: Cullum James Baldwin, San Diego, CA (US); Walker Curtis, San Diego, CA (US)

(21) Appl. No.: 16/125,379

(22) Filed: Sep. 7, 2018

(51) Int. Cl. H04N 5/232; H04N 5/225

(52) U.S. Cl. CPC H04N 5/232411; H04N 5/2258

(57) ABSTRACT

Aspects of the present disclosure relate to systems and methods for placing a camera into a low power mode. An example device may include a memory and a processor. The processor is configured to determine that the first camera is to be placed into a low power mode. The first camera is in an active mode and has a first frame capture rate. The processor further is configured to generate and output a command for placing the first camera into the low power mode. Execution of the command causes the first camera to increase the first frame capture rate to a second frame capture rate and go into the low power mode from the active mode after increasing the first frame capture rate to the second frame capture rate.

### TECHNICAL FIELD

This disclosure relates generally to image capture systems and devices, including placing one or more cameras of a multiple camera system into a low power mode.

### BACKGROUND OF RELATED ART

Many devices and systems may include multiple cameras to capture frames of a scene. One or more cameras of a multiple camera system may not be needed in some instances or for an imaging application.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to systems and methods for placing a camera into and out of a low power mode. In some example implementations, an example device may include a memory and a processor coupled to the memory. The processor is configured to determine that the first camera is to be placed into the low power mode. The first camera is in an active mode and has a first frame capture rate. The processor further is configured to generate and output a command for placing the first camera into the low power mode. Execution of the command causes the first camera to increase the first frame capture rate to a second frame capture rate and go into the low power mode from the active mode after increasing the first frame capture rate to the second frame capture rate.

In another example, a method is disclosed. The example method includes determining, by a processor of a device, that a first camera is to be placed into a low power mode. The first camera is in an active mode and has a first frame capture rate. The method also includes generating and outputting, by the processor, a command for placing the first camera into the low power mode. Execution of the command may cause the first camera to increase the first frame capture rate to a second frame capture rate and go into the low power mode from the active mode after increasing the first frame capture rate to the second frame capture rate.

In a further example, a non-transitory computer-readable medium is disclosed. The non-transitory computer-readable medium may store instructions that, when executed by a processor, cause a device to determine that a first camera is to be placed into a low power mode. The first camera is in an active mode and has a first frame capture rate. The instructions also may cause the device to generate a command for placing the first camera into the low power mode and output the command. Execution of the command may cause the first camera to increase the first frame capture rate to a second frame capture rate and go into the low power mode from the active mode after increasing the first frame capture rate to the second frame capture rate.

In another example, a device is disclosed. The device includes means for determining that the first camera is to be placed into a low power mode. The first camera is in an active mode and has a first frame capture rate. The device also includes means for generating a command for placing the first camera into the low power mode, and means for outputting the command. Execution of the command causes the first camera to increase the first frame capture rate to a second frame capture rate and causes the first camera to go into the low power mode from the active mode after increasing the first frame capture rate to the second frame capture rate. Generating the first command is in response to the determination that the first camera is to be placed into the low power mode. The device further includes means for generating a second command for placing the first camera with the second frame capture rate into the low power mode.

The device, in generating the command, may include means for generating a first command for increasing the first frame capture rate to the second frame capture rate for the first camera in the active mode and means for generating a second command for placing the first camera with the second frame capture rate into the low power mode. Generating the first command is in response to the determination that the first camera is to be placed into the low power mode. The first command and the second command may be output in a single transaction. Alternatively, the first command may be output in a first transaction, and the second command may be output in a second transaction after the first transaction. The device also may include means for receiving a confirmation that the first camera has the second frame capture rate. Generating the second command may be in response to receiving the confirmation.

The device also may include means for receiving a confirmation that the first camera has the second frame capture rate. Generating the second command is in response to receiving the confirmation. The device further may include a multiple camera system including the first camera and a second camera. The second camera may have the first frame capture rate, and the multiple camera system may include means for adjusting the first camera to have the second frame capture rate based on the first command and means for generating the confirmation that the first camera has the second frame capture rate in response to adjusting the first camera. In some examples, the second camera is a primary camera of the multiple camera system and the first camera is an auxiliary camera of the multiple camera system.

The device further may include means for determining that the first camera in the low power mode is to be removed from the low power mode and means for generating a third command for removing the first camera from the low power mode. Generating the third command may be in response to the determination that the first camera is to be removed from the low power mode. The device also may include means for generating a fourth command for decreasing the second frame capture rate to the first frame capture rate for the first camera removed from the low power mode.

In some examples, the second frame capture rate may be a maximum frame capture rate for the first camera.

The device also may include means for receiving a motion sensor measurement indicating that the device is not moving. The determination that the first camera is to be placed into the low power mode is based on the motion sensor measurement indicating that the device is not moving, and the first camera in the active mode captures frames for mapping the device's surroundings for a virtual reality, augmented reality, or extended reality application executed by the device.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is an example timing diagram of placing a second camera of a multiple camera system into and out of a low power mode.

FIG. 2 is a block diagram of an example device for performing imaging using multiple cameras.

FIG. 3 is an example timing diagram of placing a second camera of a multiple camera system into a low power mode.

FIG. 4 is an illustrative flow chart depicting an example operation for placing a second camera of a multiple camera system into a low power mode.

FIG. 5 is an example timing diagram of taking a second camera of a multiple camera system out of a low power mode.

FIG. 6 is an illustrative flow chart depicting an example operation for taking a second camera of a multiple camera system out of a low power mode.

FIG. 7 is another example timing diagram of placing a second camera of a multiple camera system into a low power mode.

FIG. 8 is another example timing diagram of taking a second camera of a multiple camera system out of a low power mode.

### DETAILED DESCRIPTION

Aspects of the present disclosure may be used for placing one or more cameras of a multiple camera system into a low power mode. In some aspects, placing a camera into a low power mode may include determining a frame capture rate for the camera.

For a system or device with multiple cameras, one or more of the cameras may not be in use when another camera of the multiple camera system is active. In one example, a second camera may be used to assist in configuring a first camera. For example, a second camera may capture frames that are used in determining the focal length, ISO or other configuration for the first camera. Once the first camera is configured, the second camera may not be in use.

In a further example, a second camera may be used for certain imaging effects. When a bokeh effect is applied to an image captured by a first camera, or portrait mode imaging is performed by a multiple camera system, a second camera may be used in conjunction with a first camera of the multiple camera system. However, when no imaging effects are to be performed, the second camera may not be in use.

In some example implementations, a device (such as a smartphone, tablet, digital camera, or other suitable imaging device) may include a dual camera module with a primary camera and an auxiliary camera. The primary camera may be active and capturing image frames while the auxiliary camera is not in use. The auxiliary camera may be used intermittently for, e.g., adjusting the focus setting (such as the camera lens position) or other configuration of the primary camera, performing 3D imaging, generating bokeh effects, generating image portraits in a portrait mode, sensing a user's surroundings during virtual reality applications or augmented reality and extended reality applications, etc. In another example, a first camera may be a color camera, and a second camera may be a black and white camera. The second camera may be used only when the amount of ambient light drops below a sufficient amount for the color camera to be used. Otherwise, the second camera may not be in use.

When one or more cameras of a multiple camera system are not in use, the cameras may be placed into a low power mode while a first camera of the multiple camera system remains in an active mode. In placing a camera into a low power mode, one or more components of the camera may be powered down or otherwise placed into a low power state that consumes less power than an active state. For example, a camera sensor, a camera shutter, one or more actuators to move a camera lens, or other camera components may be powered down or placed in a lower power state. The low power mode may be a standby mode or powered down mode.

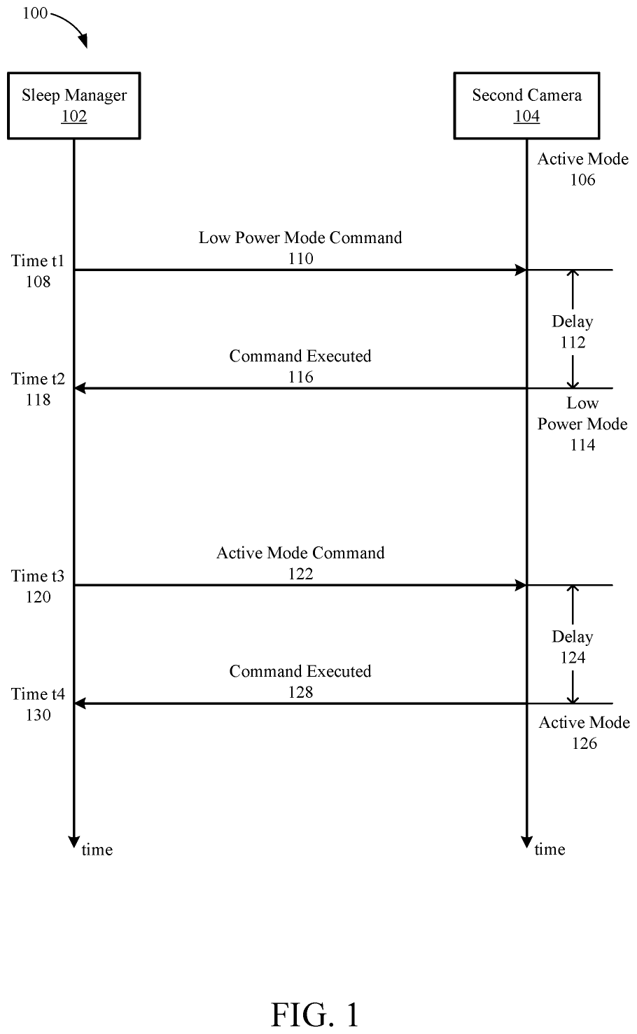

FIG. 1 is an example timing diagram 100 of placing a second camera 104 of a multiple camera system into and out of a low power mode. A device may include a sleep manager 102 (which may be part of a controller, processor, software routine, or other suitable implementation) to determine when to place the second camera 104 into and out of a low power mode while a first camera (not illustrated) remains in an active mode. The second camera 104 may be in an active mode 106 before time t1 108. A device may determine that the second camera 104 is not further needed at the moment, and a sleep manager 102 may provide a low power mode command 110 to the second camera 104 at time t1 108.

The low power mode command 110 may be received and executed by the second camera 104 in placing the second camera 104 into a low power mode 114. For example, a dual camera module may receive and execute the command 110 in placing the second camera 104 into a low power mode 114. Once the second camera 104 is placed into a low power mode 114 (at time t2 118), an indication 116 that the command was executed may be provided to the sleep manager 102. A delay 112 (from time t1 108 to time t2 118) exists between receiving the command 110 and completing execution of the command 110 (thus placing the second camera 104 from an active mode 106 into a low power mode 114). For example, some camera components may be powered down sequentially or a power down process may be performed in a specific order that requires the amount of time of the delay 112. The length of the delay 112 may be the length of time required for the second camera 104 to capture two to three frames. In this manner, the delay 112 may depend on the frame capture rate of the second camera 104.

Similarly in placing the second camera 104 from a low power mode 114 into an active mode 126, the device may determine that the second camera 104 is to be used, and the sleep manager 102 may send an active mode command 122 to the second camera 104 (such as the dual camera module including the second camera 104) at time t3 120. Execution of the command 122 may be completed at time t4 130, with an indication 128 that the command 122 was executed being sent to the sleep manager 102. The delay 124 may be a result of initializing camera components in a predefined order or a result of a predefined initialization process of the camera. The length of the delay 124 (from time t3 120 to time t4 130) in placing the second camera 104 from a low power mode 114 into an active mode 126 also may be the length of time required for the second camera 104 to capture two to three frames.

For many multiple camera systems, the frame capture rate of a second camera may be the same as the frame capture rate of the first camera. For example, the frame capture rate of an auxiliary camera may be the same as the frame capture rate of a primary camera. If the frame capture rate of the first camera is 30 frames per second (fps), the frame capture rate of the second camera may be 30 fps. As a result, the delay 112 and the delay 124 each may be 60 to 90 milliseconds (the length of time for capturing two to three frames at 30 fps).

A 60 to 90 millisecond delay in placing a second camera into an active mode (“waking” or “initializing” the second camera) may be unsuitable for some latency sensitive application and scenarios. In one example, if a second camera is used in observing a user's surroundings for virtual reality applications (or augmented reality and extended reality applications), the second camera may be placed into a low power mode when a user is stationary (which may be determined using a gyrosensor, gyroscope, inertial measurement unit (IMU) or other motion or position sensor). The second camera then may be taken out of a low power mode (“woken”) when determined that a user begins to move. A delay of 60 to 90 milliseconds may be too great for the application, and the user may bump into an object before being notified of the object in his or her surroundings. Additionally or alternatively, the latency may cause the device to be unable to track, with an acceptable latency, an object in the first camera's field of capture when the second camera is not in an active mode. As a result, a representation of the object or tracking may include an undesirable stutter, momentary losses in tracking, or a jitter or swimming movement of the tracking. For example, the object being tracked may include an image target, detectable 3D object (such as through object recognition), a natural feature in the scene (such as a light source), or a combination of one or more of the above. The object may be used for head, hand, or controller tracking, and the tracking may have errors as a result of any latency or errors in detecting and tracking the object. In some examples, a rendered indication of a controller or hand in a user's viewing stream may have jitter or errors. In some other examples for head tracking, the viewing stream itself may have jitter or errors.

In another example, when a second camera is used in configuring a first camera, and the first camera is to capture images of a sporting event or other event when the scene may change quickly, the delay in waking the second camera may delay configuring the first camera and thus delay the first camera from capturing images. Other latency sensitive camera applications may exist (such as for depth determination, stereoscopic imaging, etc.) for which a delay of 60 to 90 milliseconds may be too great, and the delay may be even longer than 60 to 90 milliseconds if the frame capture rate is less than 30 fps (such as a frame capture rate of 24 fps for each camera).

If the frame capture rate is too low, a second camera may not be placed into a low power mode when the second camera is not in use. The second camera in an active mode consumes more power than the second camera in a low power mode, and power constrained devices (such as a smartphone, tablet, or other battery powered device) may have increased power loss from not being able to place the second camera into a low power mode.

If the delay in placing the second camera into and out of a low power mode is reduced to an acceptable level (such as for a latency-sensitive application), the second camera my be placed into and out of a low power mode, thus reducing energy consumption.

In some example implementations, the frame capture rate of a second camera to be placed into and out of a low power mode may be greater than the frame capture rate of a first camera of a multiple camera system. In some examples, the second camera's frame capture rate may be increased before placing the camera into a low power mode, and the second camera's frame capture rate may be decreased after removing the camera from the low power mode. In some other examples, the frame capture rate of the second camera may be kept at a higher rate than the frame capture rate of the first camera for the multiple camera system. Since the delay in placing the second camera into and out of a low power mode depends on the second camera's frame capture rate, the delay in placing the second camera into and out of a low power mode may be decreased by increasing the second camera's frame capture rate to greater than the first camera's frame capture rate.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device with one or more cameras capable of capturing images or video (such as security systems, smartphones, tablets, laptop computers, digital video and/or still cameras, web cameras, virtual reality (VR) headsets, augmented reality (AR) headsets, extended reality (XR) headsets, digital eyewear, head mounted devices, and so on with one or more cameras or camera sensors). While described below with respect to a device having or coupled to two cameras, aspects of the present disclosure are applicable to devices having any number of cameras, and are therefore not limited to devices having two cameras. For example, a device may include a single camera whose frame capture rate may be adjustable for placing the single camera into and out of a low power mode. Thus, the present disclosure should not be limited to a multiple camera system. Further, aspects of the present disclosure are applicable for capturing still images as well as for capturing video, and may be implemented in devices having or coupled to cameras of different capabilities (such as a video camera or a still image camera).

Further, while the examples are described in relation to one or more cameras that capture visible light, aspects of the present disclosure also may apply to depth based cameras, thermal cameras, other suitable cameras, or a combination of different types of cameras. Example depth based cameras include, e.g., time of flight infrared (IR) cameras, IR cameras for capturing structured IR light pattern reflections, radar cameras/sensors, ultrasound cameras/sensors, sonar cameras/sensors, etc. IR may include near-IR (NIR), mid-IR (MIR), and far-IR (FIR). An IR camera may capture energy from the electromagnetic spectrum outside of the visible light range, and IR is not limited to the portion of the visible light range included in NIR. Another example camera or sensor may capture other types of electromagnetic energy, including microwaves and radio waves, and the cameras under the present disclosure should not be limited to capturing energy from a specific range of the electromagnetic spectrum. Thus, the present disclosure should not be limited to a specific type of camera or sensor.

The term “device” is not limited to one or a specific number of physical objects (such as one smartphone, one camera controller, one processing system and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects.

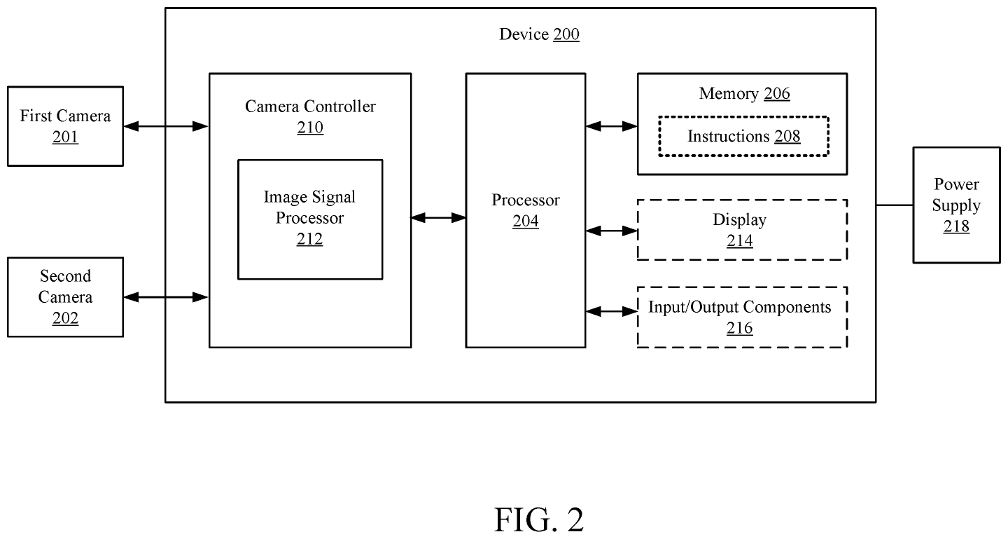

FIG. 2 is a block diagram of an example device 200 for placing one or more cameras in and out of a low power mode. The example device 200 may include or be coupled to a first camera 201, a second camera 202, a processor 204, a memory 206 storing instructions 208, and a camera controller 210. The device 200 optionally may include (or be coupled to) a display 214 and a number of input/output (I/O) components 216. The device 200 may include additional features or components not shown. In one example, a wireless interface, which may include a number of transceivers and a baseband processor, may be included for a wireless communication device. In another example, one or more motion sensors (such as an IMU or gyrosensor) may be included in a device. The device 200 may include or be coupled to additional cameras other than the first camera 201 and the second camera 202. Alternatively, the device 200 may include or be coupled to only one camera. The disclosure should not be limited to any specific examples or illustrations, including the example device 200.

The first camera 201 and the second camera 202 may be capable of capturing individual image frames (such as still images) and/or capturing video (such as a succession of captured image frames). In one example, the first camera 201 and the second camera 202 may be part of a multiple camera system (e.g., a dual camera module). Additionally or alternatively, the cameras 201 and 202 may be separated by a baseline distance used in determining depths of objects in a scene. In another example, the first camera 201 and the second camera 202 may be part of a multiple camera system including additional cameras. One or both cameras 201 and 202 may include a single camera sensor, or be a dual camera module or any other suitable module with multiple camera sensors.

The memory 206 may be a non-transient or non-transitory computer readable medium storing computer-executable instructions 208 to perform all or a portion of one or more operations described in this disclosure (such as for adjusting the frame capture rate of the second camera 202 for placing the second camera 202 into and out of a low power mode). In some example implementations, a sleep manager (such as sleep manager 102 in FIG. 1) may be embodied in the instructions 208 to be executed by a processor. The device 200 may also include a power supply 218, which may be coupled to or integrated into the device 200.

The processor 204 may be one or more suitable processors capable of executing scripts or instructions of one or more software programs (such as instructions 208) stored within the memory 206. For example, the processor 204 may execute an imaging application for the first camera 201 and the second camera 202 (such as 3D imaging, stitching or stacking of images, configuring a camera, VR applications, AR applications, portrait mode imaging, etc.). In some aspects, the processor 204 may be one or more general purpose processors that execute instructions 208 to cause the device 200 to perform any number of functions or operations. In additional or alternative aspects, the processor 204 may include integrated circuits or other hardware to perform functions or operations without the use of software. In some example implementations, the processor 204 may perform the operations of a sleep manager (such as the sleep manager 102).

While shown to be coupled to each other via the processor 204 in the example of FIG. 2, the processor 204, the memory 206, the camera controller 210, the optional display 214, and the optional I/O components 216 may be coupled to one another in various arrangements. For example, the processor 204, the memory 206, the camera controller 210, the optional display 214, and/or the optional I/O components 216 may be coupled to each other via one or more local buses (not shown for simplicity).

The display 214 may be any suitable display or screen allowing for user interaction and/or to present items (such as captured images, video, or preview images from one or both of the cameras 201 and 202) for viewing by a user. In some aspects, the display 214 may be a touch-sensitive display. In one example, the display 214 may be one or more displays for VR, AR, or 3D imaging applications.

The I/O components 216 may be or include any suitable mechanism, interface, or device to receive input (such as commands) from the user and to provide output to the user. For example, the I/O components 216 may include (but are not limited to) a graphical user interface, keyboard, mouse, microphone and speakers, and so on.

The camera controller 210 may include an image signal processor 212, which may be one or more image signal processors to process captured image frames or video provided by the first camera 201 and the second camera 202. In some example implementations, the camera controller 210 (such as the image signal processor 212) also may control operation of the first camera 201 and the second camera 202. For example, the camera controller 210 (such as the image signal processor 212) may determine and instruct adjustment of a frame capture rate of the second camera 202 for placing the second camera 202 into and out of a low power mode. In some example implementations, the camera controller 210 and/or the image signal processor 212 may perform the operations of or include a sleep manager (such as the sleep manager 102 in FIG. 1).

In some aspects, the image signal processor 212 may execute instructions from a memory (such as instructions 208 from the memory 206 or instructions stored in a separate memory coupled to the image signal processor 212). For example, the sleep manager (for providing commands to place the second camera 202 into and out of a low power mode) may be embodied in instructions executed by the image signal processor 212. The sleep manager may include bridgeware or drivers executed by the image signal processor 212 (or another suitable device component) for converting a low power mode command or active mode command from an applications processor (such as processor 204) into camera specific commands for the second camera 202.

In some other aspects, the image signal processor 212 may include specific hardware to perform one or more operations described in the present disclosure. For example, the image signal processor 212 may include specific hardware for generating commands for the second camera 202 to place the second camera 202 into and out of a low power mode. The image signal processor 212 alternatively or additionally may include a combination of specific hardware and the ability to execute software instructions. In addition or alternative to the image signal processor 212 generating commands for placing the second camera 202 into and out of a low power mode, the processor 204 or other suitable components of the device 200 may generate commands for placing the second camera 202 into and out of a low power mode.

The device 200 may include other components that are not illustrated, and the block diagram is provided in a simplified form so as not to confuse some aspects of the present disclosure. In some example implementations, the device 200 may include or be coupled to one or more components between the camera controller 210 and the cameras 201 and 202. For example, a combiner or switch (not illustrated) may exist between the cameras 201 and 202 and the camera controller 210. Other components also may exist between the cameras 201 and 202 and the camera controller 210. In some example implementations, placing a camera into a low power mode may include placing one or more other components into a low power mode. For example, the combiner may be placed into a low power mode when a camera (such as the second camera 202) is placed into a low power mode. Any number of suitable components may be placed into a low power mode.

If components other than a camera or camera sensor may be placed into a low power mode, the device 200 may adjust one or more settings of each component also to reduce the latency of the component entering and exiting a low power mode. For example, a combiner's clock rate may be increased to reduce the latency in the combiner entering the low power mode. While the following examples describe adjusting a camera setting (such as the frame capture rate) and placing a camera into low power mode, other component settings may be adjusted, and the present disclosure should not be limited to a camera entering and exiting a low power mode.

While the following examples are described in reference to the example device 200 in FIG. 2, any suitable device including or coupled to one or more cameras may be used. In some example implementations, a device including or coupled to a multiple camera system may be used. While the examples below are described regarding a multiple camera system having a first camera 201 and a second camera 202, any multiple camera system (including any number of cameras) may be used. Alternatively, a single camera may be used in performing the described operations. The below examples are for illustrative purposes only. Therefore, the present disclosure should not be limited to a specific device, system, or configuration of components, including a specific number of cameras.

When a camera (such as of a multiple camera system) is not in use, the camera may be placed into a low power mode. The delay in the camera entering and exiting a low power mode may be based on the frame capture rate of the camera. For example, the delay may be the length of time for capturing two to three frames. In this manner, the delay may be shorter for higher frame capture rates, and the delay may be longer for lower frame capture rates.

The frame capture rate of a second camera may be greater than the frame capture rate of a first camera of a multiple camera system to decrease the delay in placing the second camera into and out of a low power mode. In some example implementations, the frame capture rate of the second camera may always remain higher than the frame capture rate of the first camera, including when both cameras are in an active mode. In some other example implementations, the frame capture rate of the second camera may be increased before placing the second camera into a low power mode. The increased frame capture rate still may apply for the second camera when removing the second camera from the low power mode. The frame capture rate thus may be decreased after removing the second camera from the low power mode.

If the second camera's frame capture rate is always higher than the first camera's frame capture rate, and the second camera's frame capture rate is not adjustable, the timing of placing the second camera 202 into and out of a low power mode may be similar to the example timing diagram 100 in FIG. 1. Since the delay 112 and the delay 124 may be based on the frame capture rate of the second camera 202 (which may be an example implementation of the second camera 104), a higher frame capture rate for the second camera 202 reduces the lengths of the delays 112 and 124. In one example, if the frame capture rate of the second camera 202 is 60 fps, the delay 112 and the delay 124 each may be 30-45 milliseconds. In a further example, if the frame capture rate of the second camera 202 is 90 fps, the delay 112 and the delay 124 each may be 20-30 milliseconds. In another example, if the frame capture rate of the second camera 202 is 120 fps, the delay 112 and the delay 124 each may be approximately 15-23 milliseconds. In a further example, if the frame capture rate of the second camera 202 is 240 fps, the delay 112 and the delay 124 each may be approximately 8-11 milliseconds. In another example, if the frame capture rate of the second camera 202 is 480 fps, the delay 112 and the delay 124 each may be approximately 4-6 milliseconds.

The second camera's frame capture rate may be any rate greater than the frame capture rate of the first camera 201. However, some imaging applications require alignment of image frames captured by the first camera 201 and the second camera 202. For example, 3D imaging (such as for VR) may require temporal alignment of frames from the first camera 201 and the second camera 202 to reduce artifacts or ghosting in a composite 3D image. In some example implementations, the frame capture rate of the second camera 202 may be an integer multiple of the frame capture rate of the first camera 201. In this manner, aligning frames from the first camera 201 and the second camera 202 may be easier, or artifacts or issues in composite images may be reduced since each integer interval frame from the second camera 202 corresponds to each successive frame from the first camera 201. For example, the set of every other frame captured by the second camera 202 with a frame capture rate of 60 fps may correspond to the frames captured by the first camera 201 with a frame capture rate of 30 fps. In some example implementations, the unassociated frames from the second camera 202 may be discarded for the imaging application requiring alignment of frames from the two cameras 201 and 202.

In some other example implementations alternative to the second camera's frame capture rate always being higher than the first camera's frame capture rate and not being adjustable, the second camera's frame capture rate may be adjusted before placing the second camera 202 into a low power mode or after removing the second camera 202 from the low power mode. For example, the device 200 (FIG. 2) may be configured to increase the frame capture rate of the second camera 202 before placing the second camera 202 into a low power mode. The device 200 also may be configured to decrease the frame capture rate of the second camera 202 after removing the second camera 202 from a low power mode.

While the following examples describe adjusting the frame capture rate of a camera (such as the second camera 202), other camera settings may be adjusted for placing the camera into and out of a low power mode. In some example implementations, the camera resolution or another suitable camera setting may need to be adjusted. In one illustrative example, the camera may have a defined pixel scan rate at which a rate of camera sensor pixels may be scanned in capturing an image frame. If the frame capture rate of the camera is increased, restrictions of the pixel scan rate may cause the camera resolution to be decreased in order for the camera to be able to capture the increased number of frames within the same amount of time (since a lower number of camera sensor pixels are to be scanned). For example, a camera capturing 60 fps may have a 640×480 resolution. If the frame capture rate is increased to 480 fps, the camera resolution may be reduced to 160×120 to allow the camera to capture 480 fps. Another suitable camera setting for adjustment may be a color depth. For example, less color depth may allow a camera to more quickly capture an image frame. Other suitable camera settings may be adjusted, and the present disclosure should not be limited to adjusting a frame capture rate, a resolution, or a color depth for a camera.

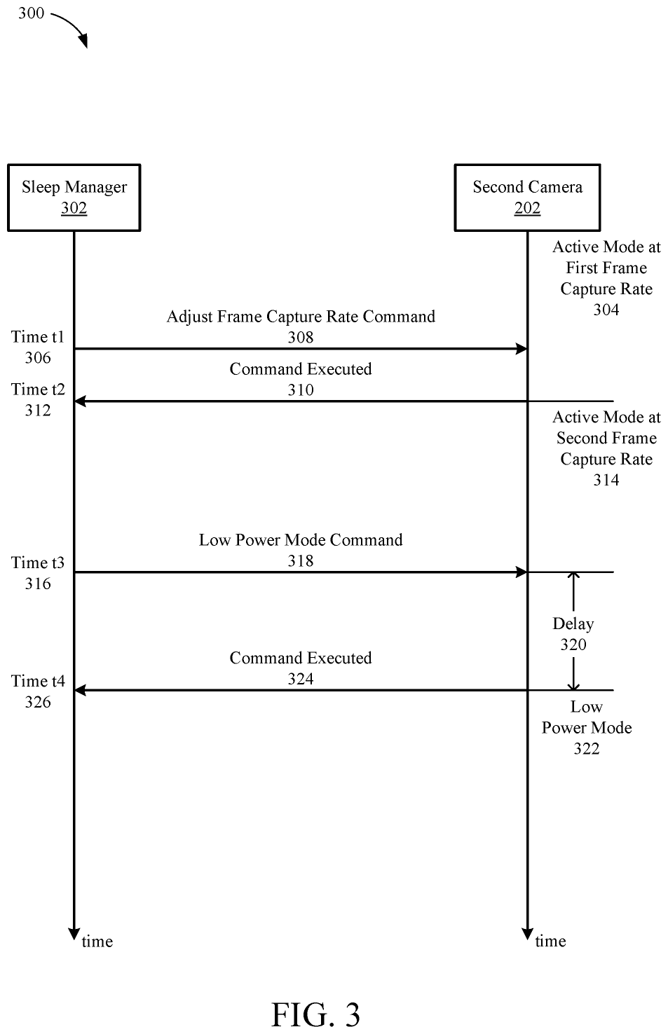

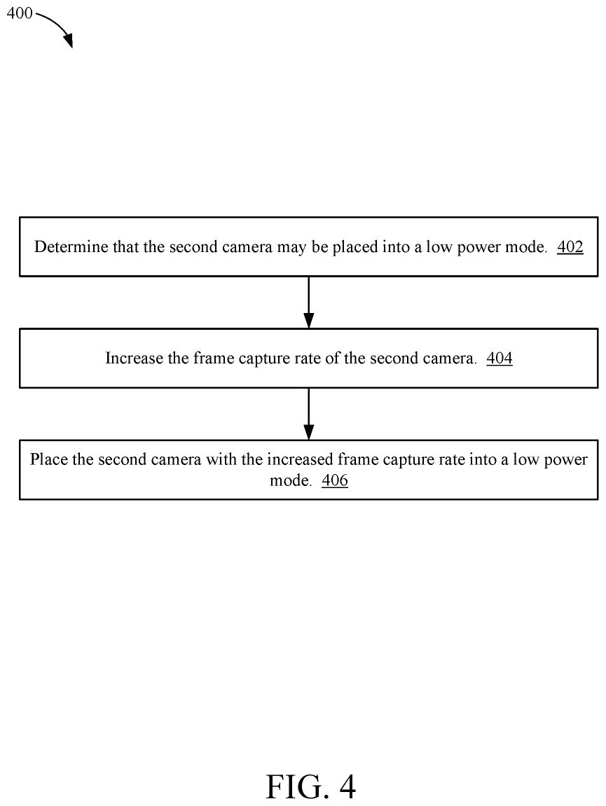

FIG. 3 is an example timing diagram 300 of placing the second camera 202 into a low power mode. The sleep manager 302 may be implemented in software, hardware, or a combination of software and hardware. For example, the image signal processor 212, another component of the camera controller 210, the processor 204, or another suitable component of the device 200 may execute the operations performed by the sleep manager 302. FIG. 4 is an illustrative flow chart depicting an example operation 400 for the device 200 to place the second camera 202 into a low power mode. The example timing diagram 300 in FIG. 3 corresponds to the example operation 400 in FIG. 4, and FIG. 3 and FIG. 4 are described concurrently below.

Referring to FIG. 3, the second camera 202 may be in an active mode with a first frame capture rate 304. In some example implementations, the first frame capture rate is the frame capture rate of the first camera 201. In some other example implementations, the first frame capture rate may be a frame capture rate other than the frame capture rate of the first camera 201. For example, the first frame capture rate may be a multiple of the first camera's frame capture rate.

Referring to FIG. 4, the device 200 may determine that the second camera 202 may be placed into a low power mode (402). In some example implementations, the device 200 (such as the camera controller 210, the image signal processor 212, or the processor 204) may determine that the second camera 202 is not to be used for a sufficient amount of time to allow for placing the second camera 202 into and out of a low power mode. For example, the amount of time may be a threshold amount of time that the device 200 compares to the amount of time until the second camera 202 is to be used.

In some further example implementations, the device 200 (such as the camera controller 210, the image signal processor 212, or the processor 204) may determine that there is no planned or scheduled use for the second camera 202. For example, if the second camera 202 is used in configuring the first camera 201, and the first camera 201 is configured, the device 200 may determine that the second camera 202 is no longer required for configuring the first camera 201.

In some example implementations, the determination as to whether the second camera 202 is to be used or may be placed into a low power mode is based on one or more sensor measurements. For example, if the second camera 202 is used to scan a user's surroundings during a VR application (or AR or XR application), the device 200 may determine that the second camera 202 may be placed into a low power mode when a gyrosensor's or IMU's measurements indicate that the device 200 is not moving. In some examples, the gyrosensor (or IMU) measurement may be compared to a movement threshold. If the measurement is less than the movement threshold, the device 200 may determine that the device movement is not sufficient or substantial enough to consider the device 200 as moving. For example, the device 200 may be considered not to be moving for small or slow movements since such movements may cause a measurement to be less than the movement threshold. In this manner, the device 200 may be considered as not moving for device movements less than a defined amount and may be considered as moving for device movements greater than a defined amount.

In some further example implementations, the determination as to whether the second camera 202 may be placed into a low power mode is based on whether any imaging application that uses the second camera 202 is being executed. For example, if the device 200 is only executing an image capture application that requires use of the first camera 201 but not the second camera 202, the device 200 may determine that the second camera 202 may be placed into a low power mode.

Based on the device 200 determining that the second camera 202 may be placed into a low power mode, the device 200 may increase the frame capture rate of the second camera 202 (404). Referring to FIG. 3, the device 200 may determine at or before time t1 306 that the second camera 202 may be placed into a low power mode. The sleep manager 302 thus may provide an adjust frame capture rate command 308 to the second camera 202. For example, the command 308 may be provided to the multiple camera system or another suitable component of the device 200 for controlling the frame capture rate of the second camera 202. The command 308 may be executed (increasing the frame capture rate of the second camera 202 from the first frame capture rate to a second frame capture rate), and an indication 310 that the command was executed may be received by the sleep manager 302 at time t2 312. The second camera 202 thus may be in an active mode with the second frame capture rate 314.

In some example implementations, the frame capture rate of the second camera 202 may be based on the shutter speed of the second camera 202. The device 200 may increase the frame capture rate of the second camera 202 by increasing the shutter speed. Additionally or alternatively, the frame capture rate of the second camera 202 may be based on the pixel sampling rate for the second camera's image sensor. For example, the sampling rate may be kept below the second camera's maximum sampling rate to align the exposure times for the first camera's image sensor and the second camera's image sensor. The device 200 therefore may increase the sampling rate for the second camera's image sensor up to a maximum sampling rate. In some other example implementations, increasing the frame capture rate of the second camera 202 may include increasing the clock rate for the second camera 202. While some examples for increasing the second camera's frame capture rate are provided, any suitable process for adjusting the frame capture rate may be performed, and the present disclosure should not be limited to the provided examples.

In some example implementations of increasing the second camera's frame capture rate, the device 200 may increase the frame capture rate to the maximum frame capture rate for the second camera 202. For example, if the second camera 202 may be configured to have a frame capture rate of 12 fps, 24 fps, 30 fps, 60 fps, or 120 fps, the device 200 may set the second camera's frame capture rate to 120 fps. In some other example implementations, the device 200 may increase the frame capture rate to any suitable frame capture rate less than the maximum for the second camera 202.

Referring back to FIG. 4, after increasing the second camera's frame capture rate, the device 200 may place the second camera 202 into a low power mode (406). In some example implementations, one or more components of the second camera 202 may be powered down or placed into a low power state. For example, the second camera's image sensor may be placed into a low power state or powered down. Other components additionally or alternatively may be powered down or placed into a low power state in placing the second camera 202 into a low power mode.

In some example implementations, the configurations of the second camera 202 are stored in a memory for when the second camera 202 is removed from the low power mode. For example, the frame capture rate, ISO, focal length, and/or other settings of the second camera 202 before being placed into a low power mode may be persisted in a memory included in or coupled to the second camera 202. In this manner, when the second camera 202 is being removed from the low power mode, the device 200 may initialize or configure the second camera 202 with the persisted camera settings (which may decrease the amount of time for removing the second camera 202 from a low power mode).

Referring back to FIG. 3, after time t2 312 when the indication 310 is received (such as at time t3 316), the sleep manager 302 may provide a low power mode command 318 to the second camera 202. In some example implementations, the low power mode command 318 may be the same as the low power mode command 110 in FIG. 1. The low power mode command 318 may be received by the second camera 202 (or the multiple camera system) and executed in placing the second camera 202 into a low power mode 322.

As described above, placing the second camera 202 into a low power mode 322 may require an amount of time (as indicated by the delay 320). For example, the length of time for capturing 2-3 frames by the second camera 202 may be needed for placing the second camera 202 into the low power mode 322. An indication 324 that the command 318 was executed may be received at time t4 326 in response to the second camera 202 being placed into the low power mode 322.

Since the first frame capture rate is lower than the second frame capture rate, the delay 320 may be shorter for a camera with the second frame capture rate than with the first frame capture rate. The times for performing the operations in the timing diagram 300 are not drawn to scale, and are for illustrative purposes only. In particular, the length of time to increase the frame rate of the second camera 202 and then place the second camera 202 into a low power mode may be less than the length of time to place the second camera 202 into a low power mode without increasing the frame rate.

For example, if the delay 112 (in FIG. 1) is based on the second camera having the first frame rate during the active mode 106, the length of time from time t1 to time t2 (indicated by delay 112) may be less than the length of time (illustrated in FIG. 3) from time t1 306 to time t4 326. As a result, the second camera 202 may be placed more quickly into a low power mode by increasing the frame capture rate than without increasing the frame capture rate.

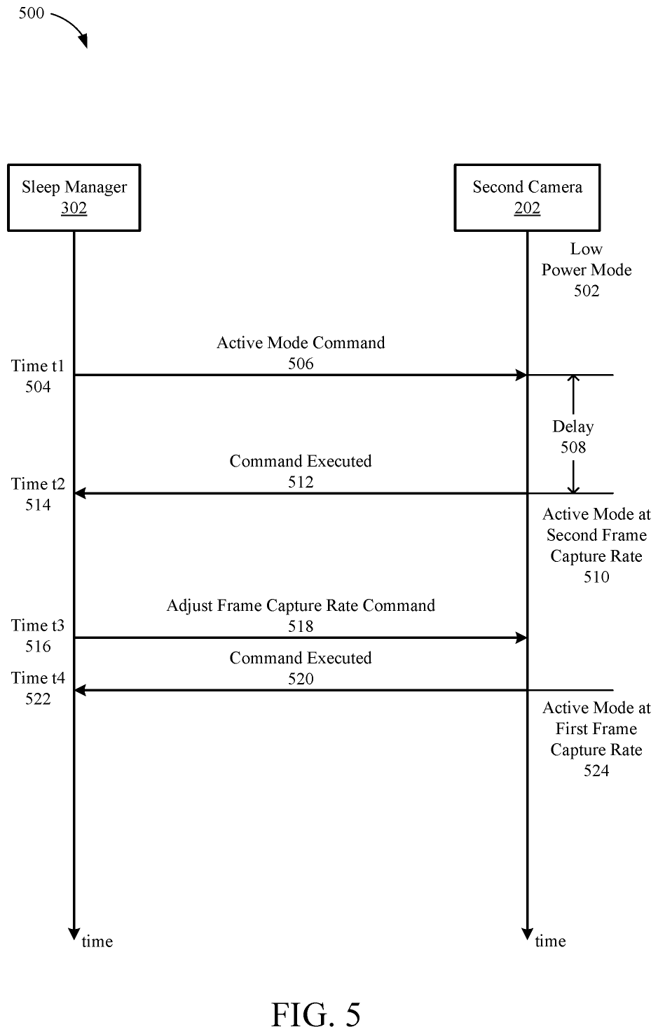

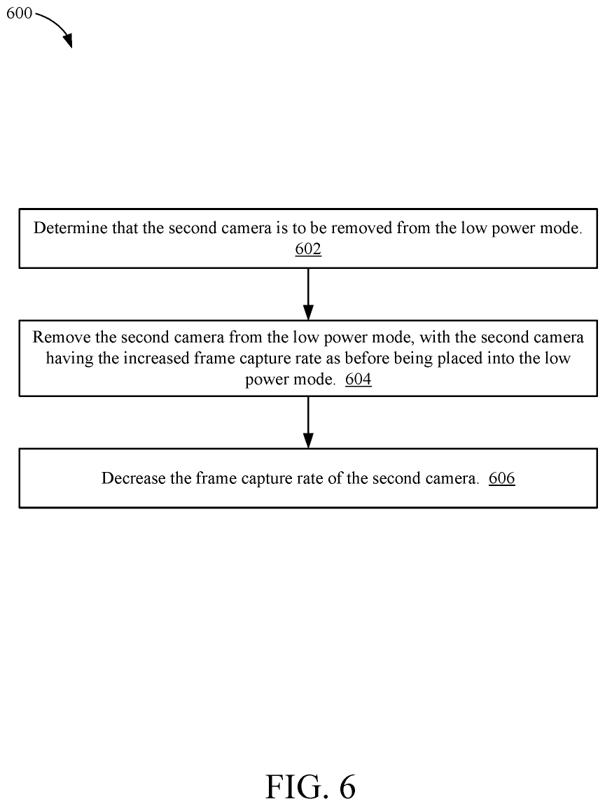

The frame capture rate for the second camera 202 also may be adjusted when taking the second camera 202 out of a low power mode (thus placing the second camera 202 into the active mode). FIG. 5 is an example timing diagram 500 of removing the second camera 202 from a low power mode. The sleep manager 302 may be the same as in FIG. 3. FIG. 6 is an illustrative flow chart depicting an example operation 600 for the device 200 to remove the second camera 202 from a low power mode. The example timing diagram 500 in FIG. 5 corresponds to the example operation 600 in FIG. 6, and FIG. 5 and FIG. 6 are described concurrently below.

Referring to FIG. 6, the device 200 may determine that the second camera 202 is to be removed from the low power mode (602). In some example implementations, the device 200 (such as the camera controller 210, the image signal processor 212, or the processor 204) may determine that an imaging application requires the second camera 202. For example, the first camera 201 may require configuration, and the second camera 202 may be used for determining new configuration settings for the first camera 201. In another example, the determination as to whether the second camera 202 is to be used (and thus is to be removed from a low power mode) may be based on one or more sensor measurements for an imaging application. For example, if the second camera 202 is used to scan a user's surroundings during a VR application, the device 200 may determine that the device 200 is moving (and thus the second camera 202 is to be removed from a low power mode) based on a gyrosensor's or IMU's measurements. In some other example implementations, the determination to remove the second camera 202 from the low power mode may be based on a schedule when the second camera 202 is to be in use or otherwise in an active mode.

Based on the device 200 determining that the second camera 202 is to be removed from the low power mode, the device 200 may remove the second camera 202 from the low power mode, with the second camera 202 having the increased frame capture rate as before being placed into the low power mode (604). Referring to FIG. 5, the second camera 202 may be in a low power mode 502. The device 200 may determine at or before time t1 504 that the second camera 202 is to be removed from the low power mode 502 (such as as described above). The sleep manager 302 thus may provide an active mode command 506 to the second camera 202. For example, the command 506 may be provided to the multiple camera system or another suitable component of the device 200 for removing the second camera 202 from the low power mode 502. The command 506 may be executed (removing the second camera 202 from the low power mode 502), and an indication 512 that the command 506 was executed may be received by the sleep manager 302 at time t2 514. The second camera 202 thus may be in an active mode with the second frame capture rate (510).

Removing the second camera 202 from the low power mode may require a length of time indicated by delay 508. For example, the length of time required to remove the second camera 202 from the low power mode may be the time required to capture 2-3 frames by the second camera 202.

When placing the second camera 202 from the low power mode 502 to the active mode 510, the device 200 may configure the second camera 202 to have the same configuration or to have one or more of the same camera settings as before the second camera 202 is placed into a low power mode. For example, if the second camera 202 is placed into a low power mode when the second camera 202 has an increased frame capture rate (such as the second frame capture rate as in FIG. 3), the second camera 202 may be removed from the low power mode 502 and placed into the active mode 510 with the increased frame capture rate (such as the second frame capture rate).

In some example implementations, the image sensor sampling rate, the shutter speed, or the clock rate of the second camera 202 may be at an increased rate or speed immediately before and after the second camera 202 being in a low power mode. In this manner, if the delay 124 in FIG. 1 is based on a first frame capture rate that is lower than the second frame capture rate, the delay 508 in FIG. 5 (based on the second frame capture rate) may be smaller than the delay 124 in FIG. 1 (based on the first frame capture rate).

Referring back to FIG. 6, after the second camera 202 is removed from the low power mode (and the second camera 202 has the increased frame capture rate), the device 200 may decrease the frame capture rate of the second camera 202 (606). In some example implementations, the device 200 may decrease the frame capture rate for the second camera 202 in a similar manner as increasing the frame capture rate (such as 404 in FIG. 4). For example, the device 200 may decrease the shutter speed, the image sensor sampling rate, and/or the clock rate of the second camera 202.

If the second camera's frame capture rate was a first frame capture rate before being increased in placing the second camera 202 into a low power mode, the second camera's frame capture rate may be decreased back to the first frame capture rate after removing the second camera 202 from the low power mode. For example, if the second camera's frame capture rate before being increased is the same as the first camera's frame capture rate, the second camera's frame capture rate may be decreased back to the first camera's frame capture rate.

Referring back to FIG. 5, after the second camera 202 is in an active mode 510 and having a second frame capture rate, the sleep manager 302 may provide an adjust frame capture rate command 518 to the second camera 202 (such as at time t3 516). For example, the command 518 may be provided to the multiple camera system or another suitable component of the device 200 for controlling the frame capture rate of the second camera 202. The command 518 may be executed (decreasing the frame capture rate of the second camera 202 from the first frame capture rate to a second frame capture rate), and an indication 520 that the command was executed may be received by the sleep manager 302 at time t4 522. The second camera 202 thus may be in an active mode with the first frame capture rate 524.

Similar to the timing diagram 300 in FIG. 3, the times for performing the operations in the timing diagram 500 are not drawn to scale, and are for illustrative purposes only. In particular, the length of time to remove the second camera 202 from a low power mode and then decrease the frame capture rate of the second camera 202 may be less than the length of time to remove the second camera 202 from a low power mode without adjusting the frame capture rate.

For example, if the delay 124 (in FIG. 1) is based on the second camera having the first frame capture rate during the active mode 126, the length of time from time t3 120 to time t4 130 (indicated by delay 124) may be greater than the length of time (illustrated in FIG. 5) from time t1 504 to time t4 522. As a result, the second camera 202 may be placed more quickly into an active mode from a low power mode when adjusting the frame capture rate than without adjusting the frame capture rate.

FIG. 3 and FIG. 5 illustrate that a frame capture rate adjustment command (such as command 308 or command 518) may be separated from a mode command (such as command 318 or command 506) by a response from the camera (such as command executed indication 310 or 512). In this manner, the commands may be sent in separate transactions. In some example implementations, the sleep manager may provide one command at a time, with receiving an indication that the command is executed before sending another command, if the camera is configured to receive and process one command at a time. In some example implementations, a camera (such as the second camera 202) may be configured to receive multiple commands before completing execution of each command. For example, the second camera 202 (or other component to execute the commands) may include or be coupled to a buffer to store commands as they are received. The commands may be pulled from the buffer and executed in the order they are received into the buffer. In some example implementations, an indication may be provided to the sleep manager 302 after each command is executed, or an indication may be provided to the sleep manager 302 after a batch of commands are executed.

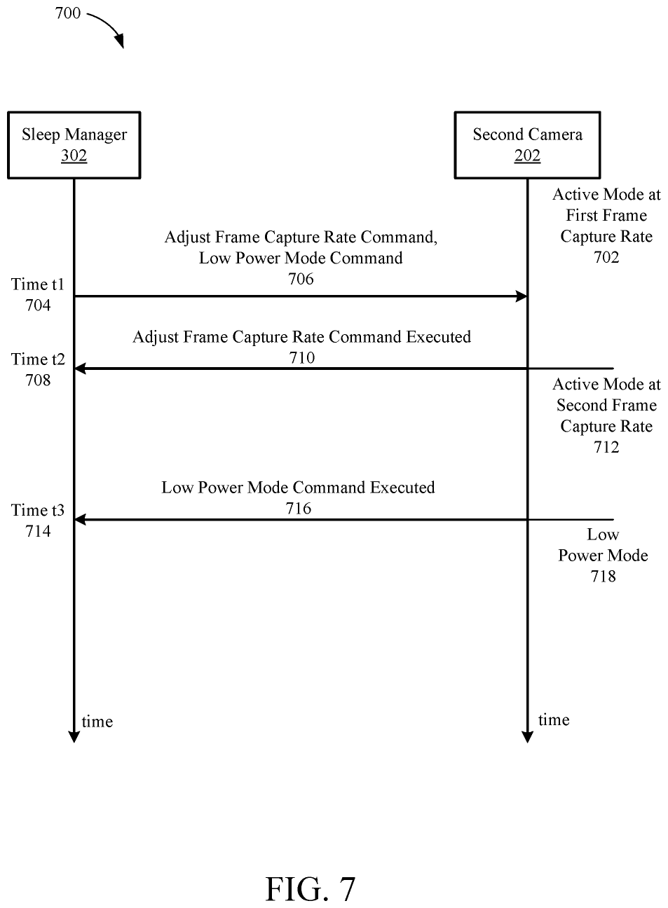

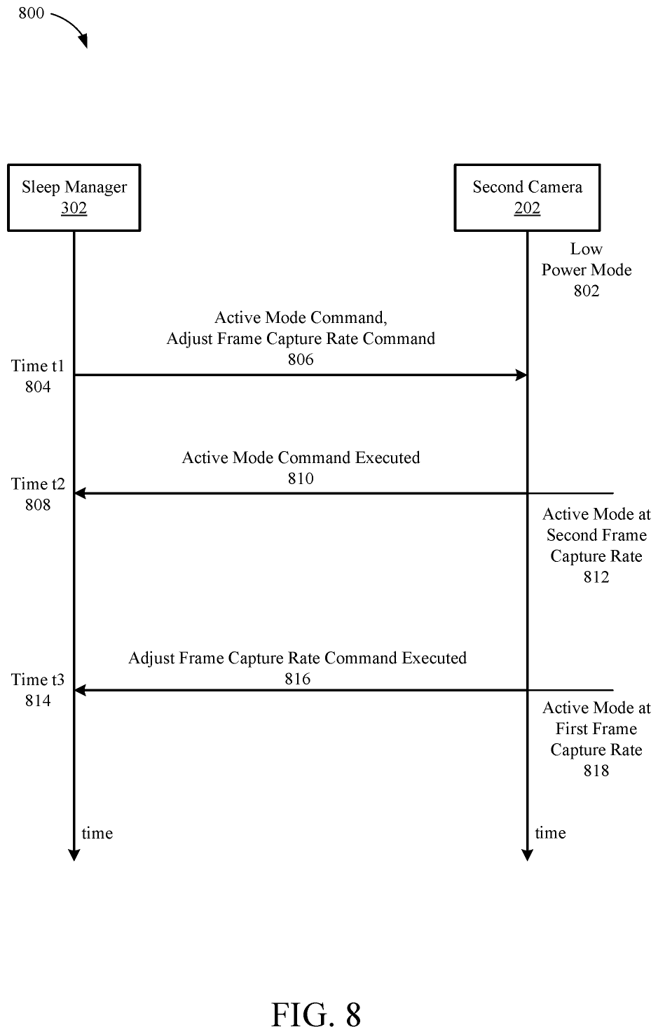

FIG. 7 is an example timing diagram 700 of placing a second camera 202 of a multiple camera system into a low power mode. FIG. 8 is an example timing diagram 800 of taking a second camera of a multiple camera system out of a low power mode. FIG. 7 and FIG. 8 illustrate that multiple commands may be sent by the sleep manager 302 in one transaction. In some other example implementations, the sleep manager 302 may send commands for the second camera 202 in sequential transactions without waiting for a response. Any received commands not being executed may be buffered until they are to be executed.

Referring to FIG. 7, the second camera 202 may be in an active mode with a first frame capture rate 702. At time t1 704, the sleep manager 302 may send an adjust frame capture command and a low power command 706 for placing the second camera 202 into a low power mode. While the commands are shown to be sent by the sleep manager 302 at one time, the commands may be sent at different times, intervals or transactions. The adjust frame capture command may be executed from time t1 704 to time t2 708. When execution of the command is completed and the second camera 202 has a second frame capture rate 712 at time t2 708, an indication 710 that the adjust frame capture rate command is executed may be sent to the sleep manager 302. The low power mode command may begin to be executed at or after time t2 708, and completion of execution may be a time t3 714. In the example timing diagram 700, an indication 716 that the low power mode command was executed may be sent to the sleep manager 302, and the second camera 202 may be in a low power mode 718 after time t3 714 until the second camera 202 is to be removed from the low power mode. While FIG. 7 illustrates an indication being sent to the sleep manager 302 for each executed command, one indication may be sent for a plurality of commands, may be sent periodically, or may be sent when requested by the sleep manager 302. Other suitable periods or times for sending an indication may be used, and the present disclosure should not be limited to the provided examples.

Referring to FIG. 8, the second camera 202 may be in a low power mode 802. Similar to FIG. 7, the sleep manager 302 may send multiple commands in one transaction. At time t1 804, the sleep manager 302 may send an active mode command and an adjust frame capture command 806 for removing the second camera 202 from a low power mode. While the commands are shown to be sent by the sleep manager 302 at one time, the commands may be sent at different times, intervals or transactions. The active mode command may be executed from time t1 804 to time t2 808. When execution of the command is completed and the second camera 202 is in an active mode with the second frame capture rate 812 at time t2 808, an indication 810 that the active mode command is executed may be sent to the sleep manager 302. The adjust frame capture rate command may begin to be executed at or after time t2 808, and completion of execution may be a time t3 814. In the example timing diagram 800, an indication 816 that the adjust frame capture command was executed may be sent to the sleep manager 302, and the second camera 202 may be in an active mode with the first frame capture rate 818 after time t3 814. Similar to FIG. 7, while FIG. 8 illustrates an indication being sent to the sleep manager 302 for each executed command, one indication may be sent for a plurality of commands, may be sent periodically, or may be sent when requested by the sleep manager 302. Other suitable periods or times for sending an indication may be used, and the present disclosure should not be limited to the provided examples.

In some example implementations where multiple commands may be sent before execution of each command, the device 200 may maintain the ordering of the commands for execution based on the order received for execution. In some other example implementations, the ordering may be based on an indication in the command as to the order of execution. For example, a time stamp for each command may be used to order execution of the commands. Any suitable means for ordering the commands may be used, and the present disclosure should not be limited to a specific example.

Allowing multiple commands to be provided before execution may reduce the latency in the second camera 202 entering and exiting a low power mode. For example, cycles in sending indications that a command is executed and waiting for the next command to be executed may be removed. As a result, a smaller number of frame capture cycles may be needed for executing any commands, applying any settings, and entering/exiting a low power mode than if commands are received and executed sequentially (thus reducing the latency).

In some example implementations of placing a camera into the active mode, camera settings may be adjusted or applied before adjusting the frame capture rate. For example, when the second camera 202 is removed from a low power mode, an initial group of camera settings may be used to initialize the second camera 202 into an active mode (with the second camera 202 having an increased frame capture rate of 120 fps during the initialization). Once the initial camera settings are applied so that image capture using the initial settings settles for the second camera 202, additional camera settings may be applied. Initial camera settings may include an initial exposure, initial focus, initial color balance, etc. The initial settings may be adjusted for initialization during a settling time for the second camera 202 to have set specific camera setting values for the initial camera settings. Additional camera settings then may adjust or add camera setting values after initialization using the initial camera settings. Additional camera settings may include an auto focus setting, auto exposure setting, etc. to adjust the initial camera setting values, or may include additional camera settings that are not needed in initializing and settling frame capture when removing the second camera 202 from the low power mode. The second camera's increased frame capture rate (such as 120 fps) then may be reduced to the normal frame capture rate (such as 30 fps) after the settings are applied.

In some other example implementations, the sleep manager 302 may provide a command that causes a plurality of actions to be performed in taking the second camera 202 in and out of a low power mode. For example, the camera controller 210 (such as the image signal processor 212) may provide a low power mode command to the second camera 202. The second camera 202 then may adjust its frame capture rate and then go into a low power mode in response to receiving the low power mode command. Similarly, the camera controller 210 (such as the image signal processor 212) may provide an active mode command to the second camera 202. The second camera 202 then may come out of a low power mode and adjust its frame capture rate after coming out of the low power mode in response to receiving the active mode command. In one example, the second camera 202 or the camera controller 210 (if controlling the operations of the second camera 202) may include a routine to be executed in receiving a low power mode or active mode command. Other suitable examples for performing a plurality of actions from receiving one command may exist, and the present disclosure should not be limited to the above example.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 206 in the example device 200 of FIG. 2) comprising instructions 208 that, when executed by the processor 204 (or the camera controller 210 or the image signal processor 212), cause the device 200 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 204 or the image signal processor 212 in the example device 200 of FIG. 2. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. For example, a camera may not be from a multiple camera system when performing one or more operations described in the present disclosure. For example, a device may include a single camera, and the frame capture rate of the single camera may be adjusted in placing the camera into and out of a low power mode. In another example, while an auxiliary camera is described in some examples for adjusting the frame capture rate, adjusting the frame capture rate may be for the primary camera or any suitable camera for which the amount of time for placing the camera into and out of a low power mode can be reduced. In a further example, a device may determine whether latency is of importance. If latency is not of importance (such as for time insensitive operations), the device may determine to reduce a frame capture rate to conserve power instead of increasing the frame capture rate and placing the camera into a low power mode. If latency is of importance (such as for time sensitive operations, including some VR, AR, or XR applications requiring object tracking), the device may determine to increase the frame capture rate and place the camera into a low power mode instead of simply reducing the frame capture rate to conserve power.

In a further example, while adjusting the frame capture rate for reducing the latency in a camera entering and exiting a low power mode is described, other camera settings may be adjusted to reduce the latency. For example, decreasing the camera resolution may reduce the latency as less camera pixels are to be scanned per frame capture. In another example, a color depth may be decreased so that a smaller range of colors may be determined for each pixel, which may reduce the latency. In a further example, a dual pixel camera sensor may switch the type of pixels to be used for capturing an image frame to reduce the latency. For example, one set of pixels may be for capturing color information, while the other set of pixels may be for capturing black and white information. The black and white information may be obtained faster than color information, which may reduce the latency. In another example, the camera's clock rate may be adjusted. Increasing the camera's clock rate may allow operations for placing the camera into a low power mode (and out of a low power state) to be executed faster than for the camera's typical clock rate, which may reduce the latency for the camera to enter and exit a low power state. Other camera settings may be adjusted to reduce the latency, and the present disclosure should not be limited to the above examples.

Additionally, the functions, steps or actions of the method claims in accordance with aspects described herein need not be performed in any particular order unless expressly stated otherwise. For example, the steps of the described example operations, if performed by the device 200, the camera controller 210, the processor 204, and/or the image signal processor 212, may be performed in any order and at any frequency. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. A method for a device to control a first camera, comprising:
determining, by a processor of the device, that the first camera is to be placed into a low power mode, wherein the first camera is in an active mode and has a first frame capture rate;
generating, by the processor, a command for placing the first camera into the low power mode; and
outputting the command, wherein execution of the command causes the first camera to:
increase the first frame capture rate to a second frame capture rate; and
go into the low power mode from the active mode after increasing the first frame capture rate to the second frame capture rate.

2. The method of claim 1, wherein generating the command comprises:
generating, by the processor, a first command for increasing the first frame capture rate to the second frame capture rate for the first camera in the active mode, wherein generating the first command is in response to the determination that the first camera is to be placed into the low power mode; and
generating, by the processor, a second command for placing the first camera with the second frame capture rate into the low power mode.

3. The method of claim 2, wherein outputting the command comprises outputting the first command and the second command in a single transaction, wherein the second command is buffered for execution.

4. The method of claim 2, wherein outputting the command comprises:
outputting the first command in a first transaction; and
outputting the second command in a second transaction after the first transaction.

5. The method of claim 4, further comprising:
receiving, by the processor, a confirmation that the first camera has the second frame capture rate, wherein generating the second command is in response to receiving the confirmation.

6. The method of claim 5, wherein the first frame capture rate is a frame capture rate of a second camera of a multiple camera system including the first camera.

7. The method of claim 6, further comprising:
receiving, by the multiple camera system, the first command;
adjusting, by the multiple camera system, the first camera to have the second frame capture rate in response to receiving the first command;
generating, by the multiple camera system, the confirmation that the first camera has the second frame capture rate in response to adjusting the first camera; and
outputting the confirmation.

8. The method of claim 7, wherein the second camera is a primary camera of the multiple camera system and the first camera is an auxiliary camera of the multiple camera system.

9. The method of claim 4, further comprising:
determining, by the processor, that the first camera in the low power mode is to be removed from the low power mode;
generating, by the processor, a third command for removing the first camera from the low power mode, wherein generating the third command is in response to the determination that the first camera is to be removed from the low power mode;
outputting the third command;
generating, by the processor, a fourth command for decreasing the second frame capture rate to the first frame capture rate for the first camera removed from the low power mode; and
outputting the fourth command.

10. The method of claim 1, wherein the second frame capture rate is a maximum frame capture rate for the first camera.

11. The method of claim 1, further comprising:
receiving a motion sensor measurement indicating that the device is not moving, wherein the determination that the first camera is to be placed into the low power mode is based on the motion sensor measurement indicating that the device is not moving and further wherein the first camera in the active mode captures frames for mapping the device's surroundings for a virtual reality, augmented reality, or extended reality application executed by the device.

12. A device configured to control a first camera, comprising:
a memory; and
a processor coupled to the memory and configured to:
determine that the first camera is to be placed into a low power mode, wherein the first camera is in an active mode and has a first frame capture rate;
generate a command for placing the first camera into the low power mode; and
output the command, wherein execution of the command causes the first camera to:
increase the first frame capture rate to a second frame capture rate; and
go into the low power mode from the active mode after increasing the first frame capture rate to the second frame capture rate.

13. The device of claim 12, wherein the processor, for generating the command, is configured to:
generate a first command for increasing the first frame capture rate to the second frame capture rate for the first camera in the active mode, wherein generating the first command is in response to the determination that the first camera is to be placed into the low power mode; and
generate a second command for placing the first camera with the second frame capture rate into the low power mode.

14. The device of claim 13, wherein the processor, for outputting the command, is configured to output the first command and the second command in a single transaction, wherein the second command is buffered for execution.

15. The device of claim 13, wherein the processor, for outputting the command, is configured to:
output the first command in a first transaction; and
output the second command in a second transaction after the first transaction.

16. The device of claim 15, wherein the processor is further configured to:
receive a confirmation that the first camera has the second frame capture rate, wherein generating the second command is in response to receiving the confirmation.

17. The device of claim 16, further comprising:
a multiple camera system including the first camera and a second camera, wherein the second camera has the first frame capture rate, the multiple camera system configured to:
receive the first command;
adjust the first camera to have the second frame capture rate in response to receiving the first command;
generate the confirmation that the first camera has the second frame capture rate in response to adjusting the first camera; and
output the confirmation.

18. The device of claim 17, wherein the second camera is a primary camera of the multiple camera system and the first camera is an auxiliary camera of the multiple camera system.

19. The device of claim 15, wherein the processor is further configured to:
determine that the first camera in the low power mode is to be removed from the low power mode;
generate a third command for removing the first camera from the low power mode, wherein generating the third command is in response to the determination that the first camera is to be removed from the low power mode;
output the third command;
generate a fourth command for decreasing the second frame capture rate to the first frame capture rate for the first camera removed from the low power mode; and
output the fourth command.

20. The device of claim 12, wherein the second frame capture rate is a maximum frame capture rate for the first camera.

21. The device of claim 12, further comprising a motion sensor coupled to the processor, wherein the processor is further configured to:
receive a motion sensor measurement from the motion sensor, the motion sensor measurement indicating that the device is not moving, wherein the determination that the first camera is to be placed into the low power mode is based on the motion sensor measurement indicating that the device is not moving and further wherein the first camera in the active mode captures frames for mapping the device's surroundings for a virtual reality, augmented reality, or extended reality application executed by the device.

22. A non-transitory computer-readable medium storing one or more programs containing instructions that, when executed by a processor of a device, cause the device to perform operations comprising:
determining that a first camera is to be placed into a low power mode, wherein the first camera is in an active mode and has a first frame capture rate;
generating a command for placing the first camera into the low power mode, wherein execution of the command causes the first camera to:
increase the first frame capture rate to a second frame capture rate; and
go into the low power mode from the active mode after increasing the first frame capture rate to the second frame capture rate.

23. The non-transitory computer-readable medium of claim 22, wherein execution of the instructions for generating the command causes the device to perform operations comprising:
generating a first command for increasing the first frame capture rate to the second frame capture rate for the first camera in the active mode, wherein generating the first command is in response to the determination that the first camera is to be placed into the low power mode; and
generating a second command for placing the first camera with the second frame capture rate into the low power mode.

24. The non-transitory computer-readable medium of claim 23, wherein execution of the instructions causes the processor to output the first command and the second command in a single transaction, wherein the second command is buffered for execution.

25. The non-transitory computer-readable medium of claim 23, wherein execution of the instructions causes the processor to output the first command in a first transaction and output the second command in a second transaction after the first transaction.

26. The non-transitory computer-readable medium of claim 25, wherein execution of the instructions causes the processor further to receive a confirmation that the first camera has the second frame capture rate, wherein generating the second command is in response to receiving the confirmation.

27. The non-transitory computer-readable medium of claim 26, wherein the first frame capture rate is a frame capture rate of a second camera of a multiple camera system including the first camera.

28. The non-transitory computer-readable medium of claim 27, wherein the second camera is a primary camera of the multiple camera system and the first camera is an auxiliary camera of the multiple camera system.

29. The non-transitory computer-readable medium of claim 25, wherein execution of the instructions causes the device to perform operations further comprising:
determining that the first camera in the low power mode is to be removed from the low power mode;
generating a third command for removing the first camera from the low power mode, wherein generating the third command is in response to the determination that the first camera is to be removed from the low power mode; and
generating a fourth command for decreasing the second frame capture rate to the first frame capture rate for the first camera removed from the low power mode.

30. The non-transitory computer-readable medium of claim 22, wherein the first frame capture rate is a frame capture rate of a second camera of a multiple camera system including the first camera.
